(19) United States
(12) Patent Application Publication
(10) Pub. No.: US 2003/0116663 A1
(43) Pub. Date: Jun. 26, 2003

(54) Agitator mill

(75) Inventors: Herbert Durr, Buchen (DE); Paul Eirich, Hardeim (DE)

Correspondence Address: BROWDY AND NEIMARK, P.L.L.C., 624 NINTH STREET, NW, SUITE 300, WASHINGTON, DC, 20001-5303, US

(73) Assignee: Maschinenfabrik Gustav Eirich GmbH & Co. KG, Hardheim (DE)

(21) Appl. No.: 10/327,206

(22) Filed: Dec. 24, 2002

(30) Foreign Application Priority Data
Dec. 24, 2001 (DE) 101 63 995.3

(51) Int. Cl. B02C 17/16

(52) U.S. Cl. 241/46.17

(57) ABSTRACT

An agitator mill comprises a grinding container with a rotatably drivable agitator disposed therein. Provision is made for a grinding-stock feed pipe with a grinding-stock feed pump and a grinding-stock discharge pipe with a grinding-stock discharge pump. At least one of the pumps is controllable.

### BACKGROUND OF THE INVENTION

1. Field of the Invention

The invention relates to an agitator mill comprising a grinding container with a grinding chamber; and an agitator, which is disposed in the grinding chamber and provided with projecting agitating tools and the agitator axis of which is parallel to the central longitudinal axis of the grinding chamber; the agitator being drivable in rotation about the agitator axis by a drive; the grinding chamber being closed by a bottom and covered, but not pressure-sealed, by an upper covering; the grinding chamber being partially filled with auxiliary grinding bodies which are movable in a mix of grinding stock and auxiliary grinding bodies; a grinding-stock feed pipe, which opens into the grinding chamber, being provided with a grinding-stock feed pump; and a separating device for separating grinding stock and auxiliary grinding bodies from each other being provided in the grinding chamber and connected to a grinding-stock discharge pipe.

2. Background Art

An agitator mill of the generic type known from U.S. Pat. No. 4,998,678 comprises a rotatably drivable grinding container, with a packing ring that serves as a splash guard being provided between the grinding container and the covering; the covering is non-rotatably disposed on the machine frame and serves as a cap. These agitator mills cannot work at overpressure. Grinding-stock discharge works on the principle of overflow and unpressurized i.e., against atmospheric pressure.

GB 1 038 153 A teaches an agitator mill having a grinding vessel with a vertical axis, in which a rotarily drivable agitator is concentrically disposed. The grinding chamber is defined upwards by a separating screen of adjustable height, by which to vary the working volume of the grinding chamber. The packing density of the auxiliary grinding bodies within the grinding chamber can thus be modified. The grinding stock, which is supplied from below by a feed pump via a feed pipe, exits through the screen and discharges from an overflow chamber. In this way grinding intensity may be affected.

German utility model 70 38 335 teaches an agitator mill having a grinding container with a vertical central longitudinal axis and with an agitator arranged concentrically therein. The grinding stock is supplied from below. Provision is made for a grinding-body displacement chamber of variable volume, in which a piston is displaceably disposed. For facility of start-up of the agitator mill, part of the auxiliary grinding bodies can be withdrawn into this chamber and pushed back into the grinding chamber during regular grinding. The grinding stock discharges openly on top of the grinding container.

### SUMMARY OF THE INVENTION

It is an object of the invention to further develop an agitator mill of the generic type such that influencing the working volume of the grinding container is feasible without modification of the volume of the agitator mill.

According to the invention, this object is attained in an agitator mill of the generic type by the features which consist in that a grinding-stock discharge pump is provided in the grinding-stock discharge pipe; and in that the grinding-stock feed pump and/or the grinding-stock discharge pump are controllable. Due to the fact that not only grinding stock supply but also grinding stock discharge takes place by means of a pump and that the two pumps are, as it were, interadjustable, it is possible to modify the filling ratio of the agitator mill and thus the working volume of the grinding chamber. The measures according to the invention enable part of the auxiliary grinding bodies in the grinding chamber to defy the grinding process partially or totally without being removed from the entirety of the grinding chamber because, above the separating device, there is only little intensity of agitation of the mix of grinding-stock and auxiliary grinding bodies.

The measures according to the invention are of special advantage in the case of agitator mills that comprise the additional features according to which the grinding container is rotatably drivable; and/or according to which the agitator is disposed eccentrically of the central longitudinal axis of the grinding container; and/or according to which the grinding-stock feed pipe opens into the grinding chamber in vicinity to the bottom.

In keeping with advantageous embodiments of the invention, the separating device may be variable radially or parallel to the axis of the agitator mill.

Further features, advantages and details of the invention will become apparent from the ensuing description of some exemplary embodiments, taken in conjunction with the drawing.

### BRIEF DESCRIPTION OF THE DRAWING

FIG. 1 is a vertical central longitudinal section of a first embodiment of an agitator mill;

FIG. 2 is a view, on a strongly enlarged scale, of a detail of FIG. 1, showing a separating device;

FIG. 3 is a plan view of the separating device of FIG. 2;

FIG. 4 is a vertical central longitudinal section of a second embodiment of an agitator mill;

FIG. 5 is a vertical central longitudinal section of a third embodiment of an agitator mill;

FIG. 6 is a vertical central longitudinal section of a fourth embodiment of an agitator mill;

FIG. 7 is a plan view of the separating device of the agitator mill according to FIG. 7;

FIG. 8 is a section of a detail of a fifth embodiment of an agitator mill with a separating device allocated to the agitator;

FIG. 9 is a vertical central longitudinal section of a sixth embodiment of an agitator mill; and

FIG. 10 is a vertical central longitudinal section of a detail of the agitator mill according to FIG. 9.

### DESCRIPTION OF PREFERRED EMBODIMENTS

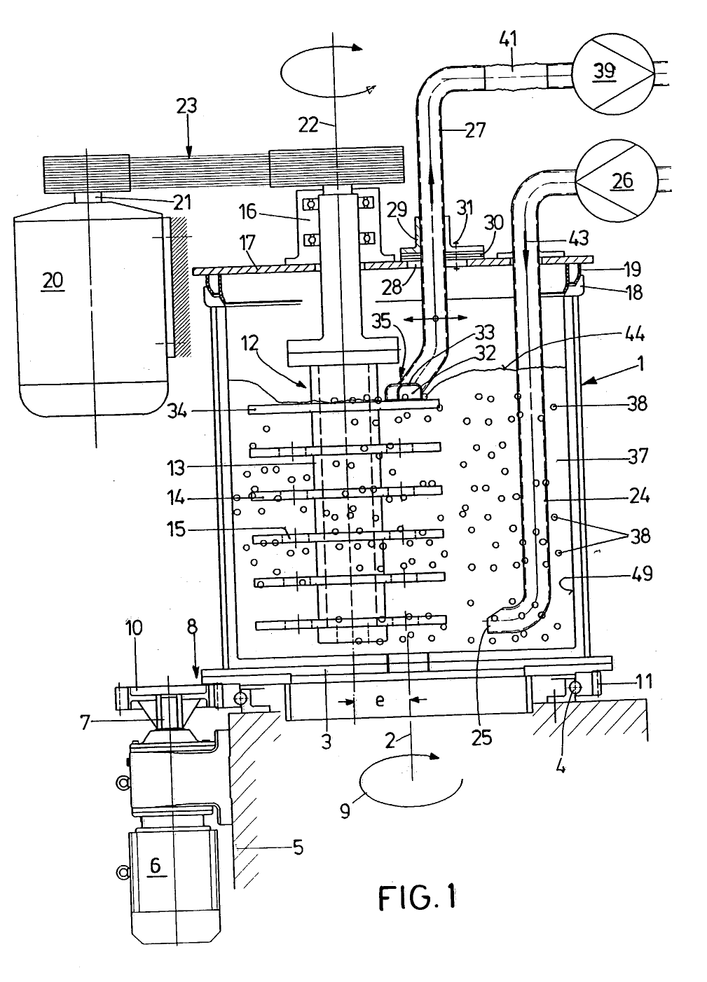

The agitator mill seen in FIGS. 1 to 3 comprises a substantially cylindrical grinding container 1, the central longitudinal axis 2 of which is vertical i.e., the grinding container 1 is vertical. It is closed downwards by a bottom 3 that runs crosswise of the axis 2. It supports itself on a machine frame 5 (roughly outlined) by means of a pivot bearing 4 that is concentric of the axis 2 i.e., the grinding container 1 is rotatable about its central longitudinal axis 2. A grinding-container driving motor 6, which is supported on the machine frame 5, is provided as a rotary drive for the grinding container 1; the shaft 7 of the motor 6 runs parallel to the axis 2, via a gear drive 8 driving the grinding container 1 in the direction of rotation 9. To this end, a pinion 10 is mounted on the shaft 7, engaging with a gear ring 11 which is mounted on the bottom 3 of the grinding container 1 around the pivot bearing 4. Due to the great pinion-10-to-gear-ring-11 step-down ratio, the grinding container 1 can be driven at a comparatively low rotational speed.

An agitator 12 is disposed in the grinding container 1, substantially and conventionally comprising an agitator shaft 13 and agitating tools 14 that are mounted thereon and stand out radially there-from. The agitating tools 14 are agitating disks with penetration openings 15. In its upper region opposite the bottom 3, the agitator shaft 13 is over-mounted in an agitator-shaft bearing 16. This bearing 16 is held in a non-rotatable, frontal covering 17, which is supported on the machine frame 5 in a manner not shown. A packing ring 19 is placed between the covering 17 and the upper edge 18 of the grinding container 1; consequently, it is arranged concentrically with the central longitudinal axis 2 of the grinding container 1. The packing ring 19 is not connected with the edge 18 of the grinding container 1, because the container 1 is rotatable and the covering 17, which serves as a cap, is arranged stationarily and detachably on the machine frame 5. The covering 17 and the packing ring 19 serve as a splash guard; the grinding container 1 is not pressure-sealed.

The agitator 12 is actuated by an agitator driving motor 20, which is connected to the machine frame 5, and the shaft 21 of which is parallel to the agitator axis 22. Actuation is translated to the agitator shaft 13 by means of a belt drive 23. The agitator axis 22 and the central longitudinal axis 2 of the grinding container 1 are parallel to one another and misaligned by an eccentricity e.

A grinding-stock feed pipe 24 passes through the non-rotatable covering 17 and is held thereby, its outlet 25 being in proximity to the bottom 3 of the grinding container 1. A controllable grinding-stock feed pump 26 is arranged in the feed pipe 24. Provision is also made of a grinding-stock discharge pipe 27, which passes through an oblong hole 28 in the covering 17, the hole 28 extending approximately radially to the agitator axis 22. It is held in a clamping flange 29 which is supported by shims 30 on the covering 17 where it is fixable by screws 31 (roughly outlined). In every position, the clamping flange 29 covers the oblong hole 28. The inlet 32, which is positioned inside the grinding container 1, is defined by a suction port 33, which is arranged above the agitating tool 14 in the form of a plane solid disk 34. The solid disk 34 has no penetration openings 15. The solid disk 34 and the suction port 33 constitute a separating device 35. Located between the suction port 33 and the top side of the solid disk 34 is a suction slot 36, the width s of which can be set by means of the shims 30. The width s of the slot 36 is always set such that the width s is distinctly smaller than the smallest diameter d of the auxiliary grinding bodies 38 which largely fill the cylindrical grinding chamber 37 that is formed in the grinding container 1, with s≈5 0.5 dₘᵢₙ and 2.0 mm≦d≦10.0 mm applying. Disposed in the grinding-stock discharge pipe 27 is an equally controllable grinding-stock discharge pump 39. Furthermore, a flexibly resilient pipe section 41 is arranged in the discharge pipe 27, extending substantially radially to the axis 2 and enabling the suction port 33 to be set radially in the direction of adjustment 40.

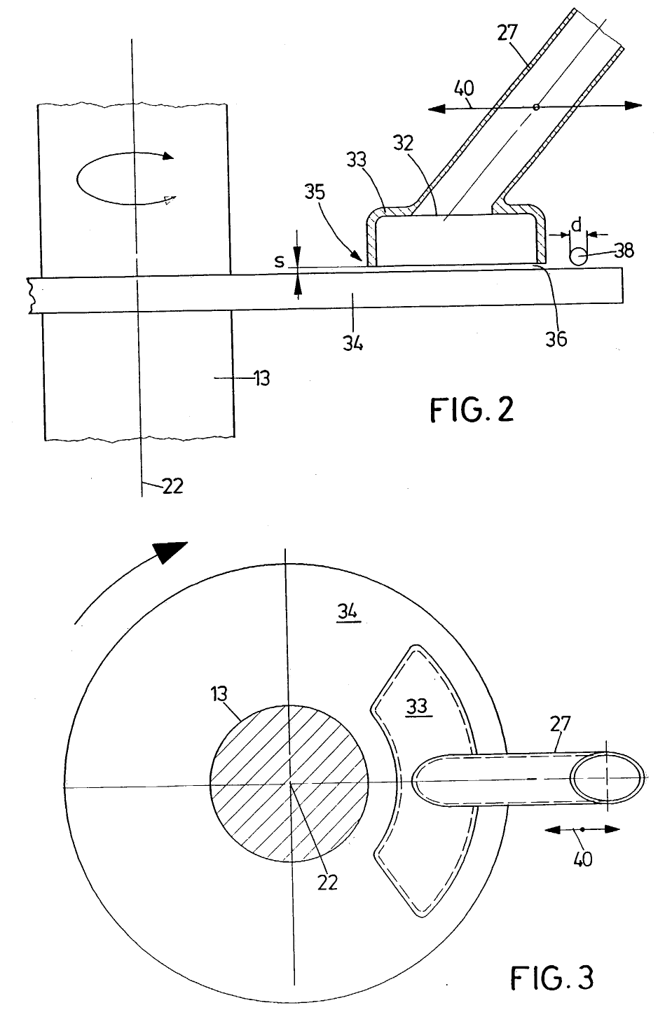

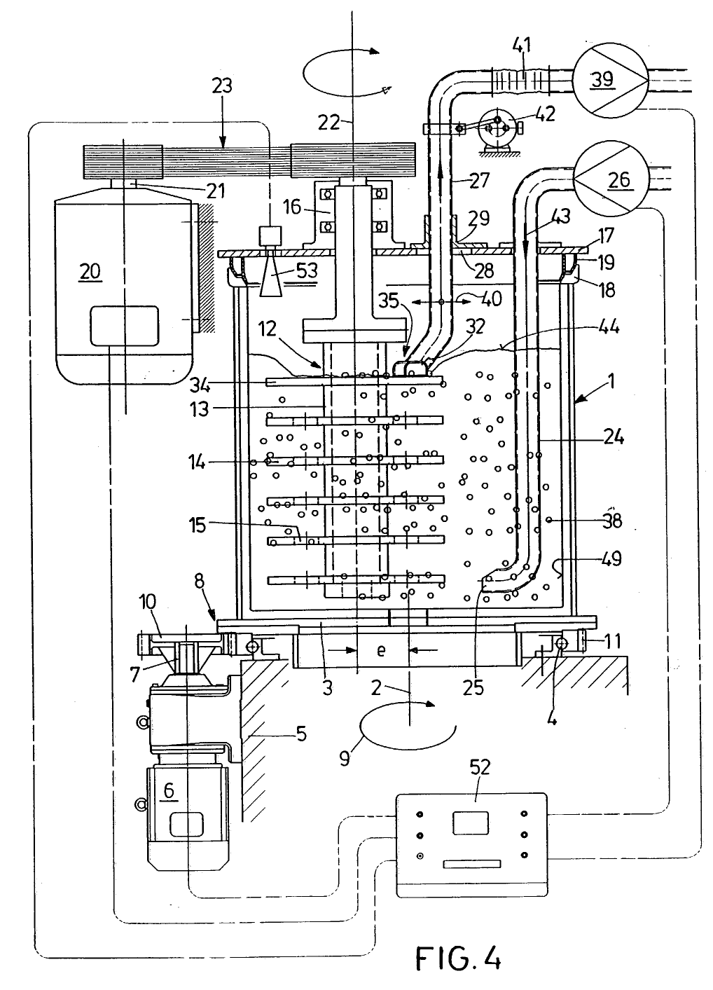

The exemplary embodiment of FIG. 4 differs from that of FIG. 2 only in that the part of the grinding-stock discharge pipe 27 that passes through the covering 17 and is held in the clamping flange 29 is not variable in the direction of adjustment 40 and then fixable by screws, but that it is drivable by a swing drive 42 to reciprocate in the direction of adjustment 40. In this case, the clamping flange 29 is of course not joined to the covering 17 by means of screws, but rests thereon so that the grinding-stock discharge pipe 27 is movable to and fro in the oblong hole 28. While the suction port 33 of the embodiment according to FIGS. 1 to 3 is radially adjustable by lateral distances for reduction of wear on the solid disk 34, this radially reciprocating motion is implemented continuously by the swing drive 42 in the embodiment of FIG. 4, as a result of which the suction slot 36 is kept permanently clear.

During grinding, the level to which the grinding chamber 37 is filled with auxiliary grinding bodies 38 is constant. The auxiliary-grinding-body loading is approximately 90 percent. By means of the grinding-stock feed pump 26, pumpable i.e., free flowing grinding stock is supplied in the direction of feed 43 through the grinding-stock feed pipe 24 and into the grinding chamber 37. By corresponding high-speed actuation of the agitator 12 and, as the case may be, of a corresponding rotary drive of the grinding container 1, high-intensity motion of the mix of grinding stock and auxiliary grinding bodies takes place in a known manner in the grinding chamber 37, inciting a process of intensive grinding and dispersion. This process of grinding and dispersion depends on the density of packing of the auxiliary grinding bodies 38 in the grinding chamber 37 i.e., on the working volume in which the auxiliary grinding bodies 38 are distributed during the grinding process. Corresponding interadjustment of the grinding-stock feed pump 26 and the grinding-stock discharge pump 39 by means of a control unit 52 helps regulate the level of the surface 44 of the grinding stock. To this end, provision is also made for a level indicator 53 which permanently monitors the level of the surface 44 and transmits it to the control unit 52. As seen in FIGS. 1 and 4—it can be approximately level with, or reach beyond, the top side of the solid disk 34 i.e., of the uppermost agitating tool 34. Auxiliary grinding bodies 38 are available in this area above the solid disk 34; they are only slightly accelerated by the agitator 12 so that the grinding and dispersing effect is strongly reduced. Consequently, the working volume of the grinding chamber is reduced due to the fact that part of the auxiliary grinding bodies 38 are withdrawn from the active grinding process. If however—as seen in FIGS. 1 and 4—the surface 44 is intended to be approximately flush with the solid disk 34, then the discharge pump 39 must work at a slightly greater capacity than the feed pump 26.

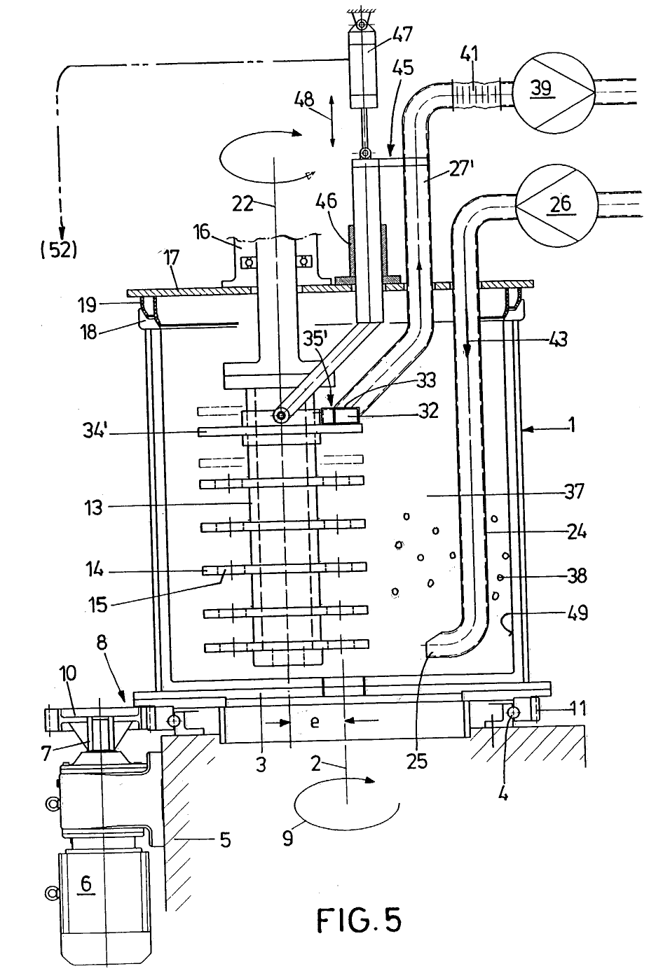

The embodiment according to FIG. 5 differs from the embodiments described above in that the grinding-stock discharge pipe 27′ and the solid disk 34′, and thus the separating device 35′, are jointly variable vertically in the direction of the agitator axis 22. To this end, the solid disk 34′, which is non-rotatably, but axially displaceably arranged on the agitator shaft 13, is joined to a control-rod mechanism 45, which is passed outwards through the covering 17 in a sliding bearing 46 on the covering 46. The control-rod mechanism 45 is joined to the discharge pipe 27′ which is parallel thereto. It is shifted in parallel to the agitator axis 22 by means of a pressurized piston-cylinder drive i.e., a linear drive 47, which can also be triggered by the control unit 52. Corresponding actuation of the linear drive 47 in the direction of adjustment 48 helps adjust the suction port 33, together with the solid disk 34′, in the direction of adjustment 48 i.e., parallel to the agitator axis 22, whereby the working volume of the grinding chamber is modified in the same way. In this case too, corresponding regulation of the grinding-stock feed pump 26 and of the grinding-stock-discharge pump 39 will influence the level to which the grinding chamber 37 is filled, regardless of the position of the separating device 35′. In this mode of operation, the discharge pump 39 can permanently be operated at a higher capacity than the feed pump 26, whereby the surface 44 is kept constantly level with the separating device 35.

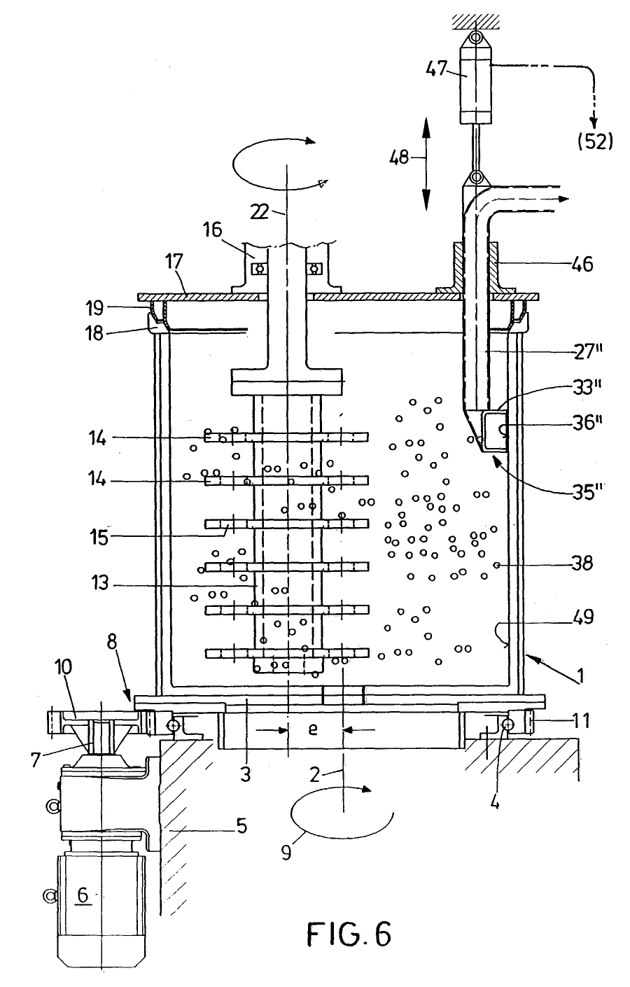

The exemplary embodiment according to FIGS. 6 and 7 differs from the embodiments described above in that the separating device 35″ is designed for the suction port 33″ to form a suction slot 36″ towards the inside wall 49 of the grinding container 1. The grinding-stock discharge pipe 27″ is vertically displaceable—as in the exemplary embodiment of FIG. 5. Thus the separating device 35″ is shifted vertically in the same way as in the embodiment of FIG. 5; modification of the working volume of the grinding chamber takes place in the same way. In this embodiment according to FIGS. 6 and 7, the uppermost agitating tool 14 need not be a plane solid disk, there being no need for it to form a closed surface opposite the suction port 33″. It can be provided with penetration openings 15 as the rest of the agitating tools 14. For reason of clarity, FIG. 6 does not show the grinding-stock feed pipe. The mode of operation is the same as in FIG. 5.

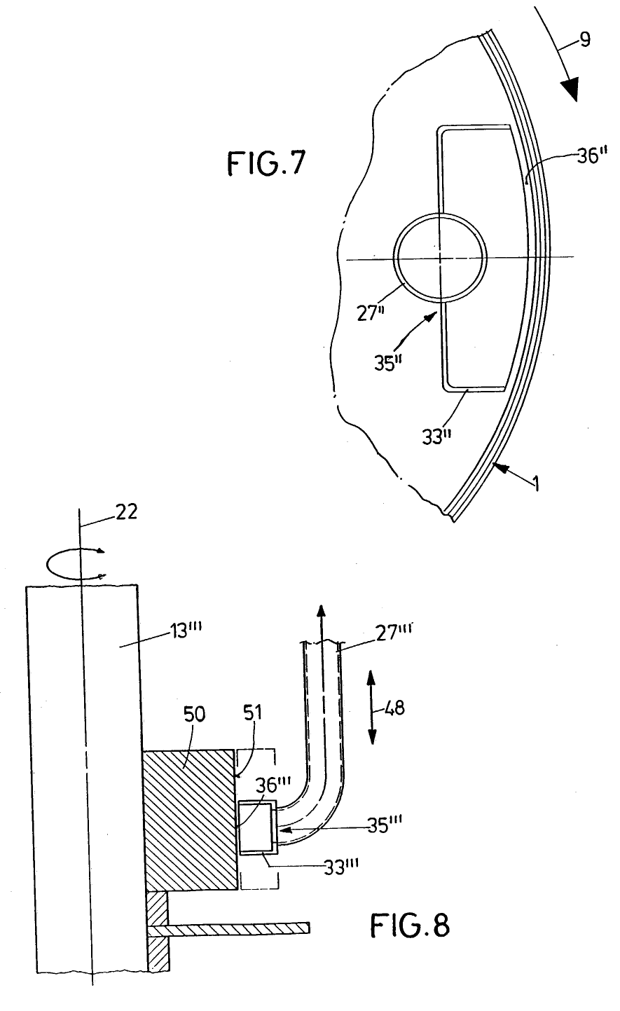

In the embodiment according to FIG. 8, the separating device 35″ is formed between the suction port 33′″ and the agitator shaft 13′″, the diameter of which may be reinforced in this area by a counter ring 50. Vertical displacement of the grinding-stock discharge pipe 27′″ in the direction of adjustment 48 takes place in the same way as in the embodiments of FIGS. 5 and 6, 7. The counter ring 50 has an external cylindrical surface 51, with a suction slot 36′″ being formed between the surface 51 and the suction port 33′″.

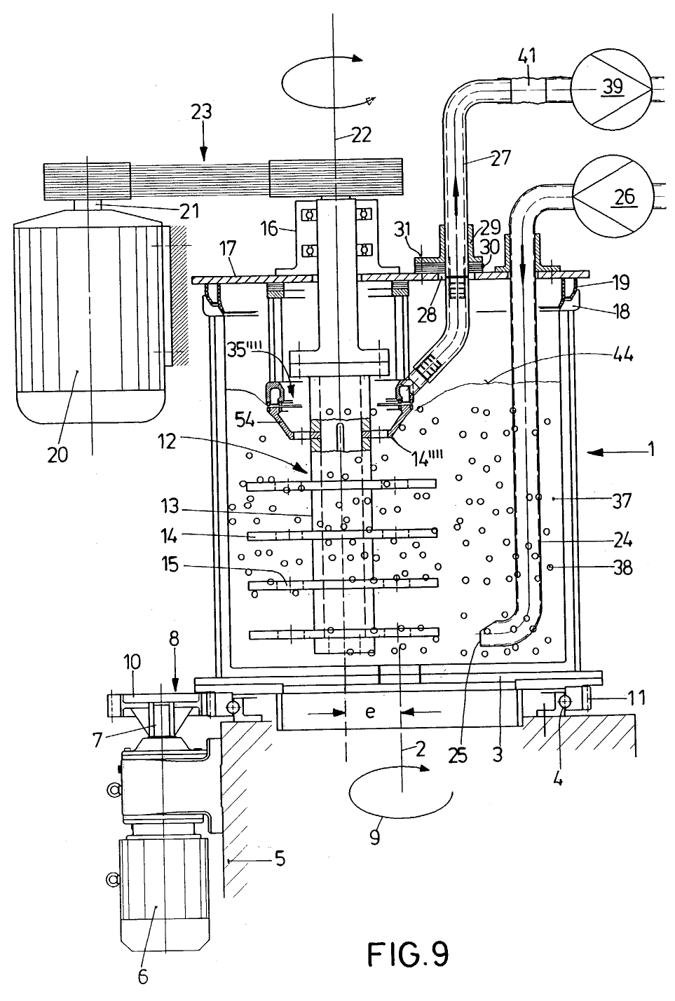

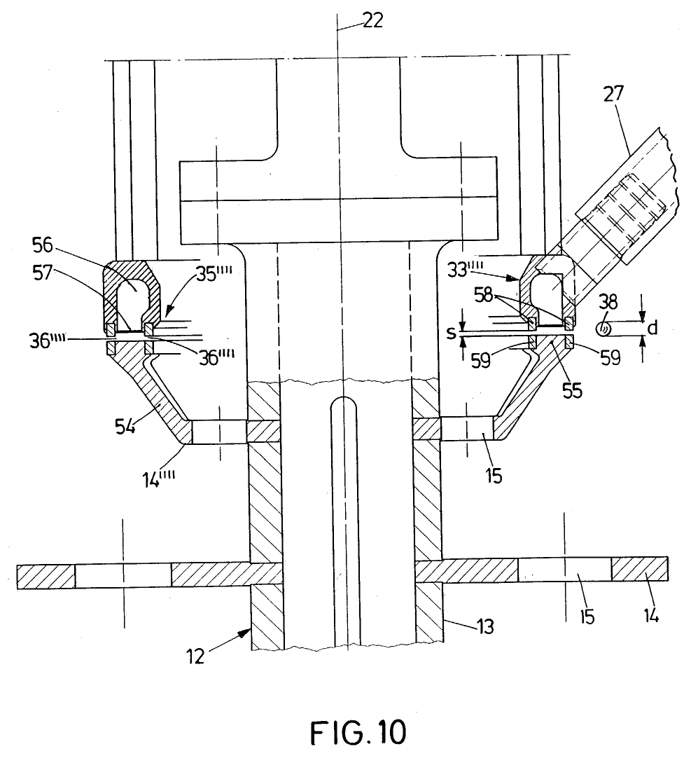

The embodiment of FIGS. 9 and 10 largely corresponds to that of FIG. 1. The entire control system can be designed as explained in connection with FIG. 4. The separating device 35″″ differs substantially. The uppermost agitating tool 14″″ has a smaller diameter and is peripherally equipped with spokes 54 which are directed outwards and upwards. The outer ends of the spokes 54 have a ring 55 which is connected for rotation with the agitator shaft 13. Disposed above the ring 55 is an annular suction port 33″″ of hard elastic material, for instance rubber, of a cross-sectional shape of an upside down U which comprises a discharge duct 56. The discharge duct 56 is connected to the grinding-stock discharge pipe 27 and has a grinding-stock opening 57 that is directed towards the ring 55. Two wearing rings 58 are mounted on the suction port 33″″ on either side of the grinding-stock opening 57, with a wearing ring 59 that is mounted on the ring 55 being allotted to the wearing rings 58. Between themselves, these wearing rings 58, 59, which are arranged in pairs, define a suction slot 36″″ of the width s described above.

The mode of operation is the same as explained above in connection with FIGS. 1 to 4. Setting the width s of the suction slot 36″″ and aligning the wearing rings 58, 59 may be effected by the available possibilities of adjustment in the same way as in the embodiment of FIGS. 1 to 3, namely the oblong hole 28 on the one hand and the clamping flange 29 with shims 30 on the other.

As seen from the above explanations, the suction port 33″″—apart from the described possibilities of adjustment—is stationary, in particular non-rotatable, in relation to the grinding chamber 1.

What is claimed is:

1. An agitator mill, comprising
a grinding container (1) with an inside wall (49) and a grinding chamber (37); and
an agitator (12), which is disposed in the grinding chamber (37) and provided with projecting agitating tools (14, 34, 34′, 14″″) and the agitator axis (22) of which is parallel to the central longitudinal axis (2) of the grinding chamber (37);
the agitator (12) being drivable in rotation about the agitator axis (22) by a drive (20);
the grinding chamber (37) being closed by a bottom (3) and covered, but not pressure-sealed, by an upper covering (17);
the grinding chamber (37) being partially filled with auxiliary grinding bodies (38) which are movable in a mix of grinding stock and auxiliary grinding bodies;
a grinding-stock feed pipe (24), which opens into the grinding chamber (37), being provided with a grinding-stock feed pump (26); and
a separating device (35, 35′, 35″, 35″″) for separating grinding stock and auxiliary grinding bodies from each other being provided in the grinding chamber (37) and connected to a grinding-stock discharge pipe (27, 27′, 27″, 27′″);
wherein a grinding-stock discharge pump (39) is provided in the grinding-stock discharge pipe (27, 27′, 27″, 27′″); and
wherein at least one of the grinding-stock feed pump (26) and the grinding-stock discharge pump (36) are controllable.

2. An agitator mill according to claim 1, wherein the grinding-stock feed pump (26) and the grinding-stock discharge pump (39) are controllable.

3. An agitator mill according to claim 1, wherein the grinding container (1) is rotatably drivable.

4. An agitator mill according to claim 1, wherein the agitator (12) is disposed eccentrically of the central longitudinal axis (2) of the grinding container (1).

5. An agitator mill according to claim 1, wherein the grinding-stock feed pipe (24) opens into the grinding chamber (37) in vicinity to the bottom (3).

6. An agitator mill according to claim 1, wherein the separating device (35) is variable radially to the agitator axis (22).

7. An agitator mill according to claim 1, wherein the separating device (35′, 35″, 35′″) is variable in parallel to the agitator axis (22).

8. An agitator mill according to claim 1, wherein the separating device (35, 35′, 35″, 35′″, 35″″) is formed by a suction port (33, 33″, 33′″, 33″″), which is connected to the grinding-stock discharge pipe (27, 27′, 27″, 27′″), and by an opposite surface, a suction slot (36, 36″, 36′″, 36″″) being formed between the suction port (33, 33″, 33′″, 33″″) and the opposite surface.

9. An agitator mill according to claim 8, wherein the width s of the suction slot (36, 36″, 36′″, 36″″) is adjustable.

10. An agitator mill according to claim 8, wherein the opposite surface is formed by a top side of a disk (34) that is disposed on the agitator (12).

11. An agitator mill according to claim 10, wherein the suction port (33, 33″″) is adjustable radially to the disk (34).

12. An agitator mill according to claim 10, wherein the suction port (33) is variable radially to the disk (34).

13. An agitator mill according to claim 10, wherein the disk (34) and the suction port (33″) are variable in the direction of the agitator axis (22).

14. An agitator mill according to claim 8, wherein the opposite surface is formed by the inside wall (49) of the grinding container (1).

15. An agitator mill according to claim 8, wherein the opposite surface is formed by a cylindrical surface (51) on the agitator (12).

16. An agitator mill according to claim 8, wherein the suction port (33″″) is annular and has a discharge duct (56) that is open towards the opposite surface.

17. An agitator mill according to claim 16, wherein the opposite surface is a ring (55) that is joined to the agitator shaft (13).

18. An agitator mill according to claim 17, wherein wearing rings (58, 59) are mounted on the suction port (33″″) on the one hand and on the ring (55) on the other hand, which are allocated to each other in pairs and define a suction slot (36″″) between them.
